(19) United States
(12) Patent Application Publication
(10) Pub. No.: US 2005/0061789 A1
(43) Pub. Date: Mar. 24, 2005

(54) Laser beam machine

(76) Inventors: Yusuke Nagai, Tokyo (JP); Satoshi Kobayashi, Tokyo (JP); Yukio Morishige, Tokyo (JP); Koichi Shigematsu, Tokyo (JP)

Correspondence Address: SMITH, GAMBRELL & RUSSELL, LLP, 1850 M STREET, N.W., SUITE 800, WASHINGTON, DC, 20036, US

(21) Appl. No.: 10/938,728

(22) Filed: Sep. 13, 2004

(30) Foreign Application Priority Data
Sep. 18, 2003 (JP) 2003-325522

(51) Int. Cl. B23K 26/06

(52) U.S. Cl. 219/121.75

(57) ABSTRACT

A laser beam machine comprising a workpiece holding means for holding a workpiece, a laser beam application means comprising a condenser for applying a laser beam to the workpiece held on the workpiece holding means, and a focusing point position adjusting means for adjusting the position of the focusing point of the laser beam applied by the condenser, wherein the machine further comprises a temperature detection means for detecting a temperature of the condenser and a control means for controlling the focusing point position adjusting means based on the temperature of the condenser detected by the temperature detection means.

### FIELD OF THE INVENTION

The present invention relates to a laser beam machine for processing a workpiece such as a semiconductor wafer.

### DESCRIPTION OF THE PRIOR ART

In the production process of a semiconductor device, a plurality of areas are sectioned by dividing lines called “streets” arranged in a lattice pattern on the front surface of a substantially disk-like semiconductor wafer and a circuit such as IC, LSI or the like is formed in each of the sectioned areas. Individual semiconductor chips are manufactured by cutting this semiconductor wafer along the streets to divide it into the circuit-formed areas. An optical device wafer in which gallium nitride-based compound semiconductors are laminated on the front surface of a sapphire substrate is also cut along dividing lines to be divided into individual optical devices such as light emitting diodes or laser diodes, which are widely used in electric equipment.

Cutting along the streets of the semiconductor wafer or optical device wafer is generally carried out by a cutting machine called “dicer”. This cutting machine comprises a chuck table for holding a workpiece such as a semiconductor wafer or optical device wafer, a cutting means for cutting the workpiece held on the chuck table, and a moving means for moving the chuck table and the cutting means relative to each other. The cutting means comprises a rotary spindle that is rotated at a high speed and a cutting blade mounted to the spindle. The cutting blade comprises a disk-like base and an annular cutting edge that is mounted to the side wall outer peripheral portion of the base and formed as thick as about 20 μm by fixing diamond abrasive grains having a diameter of about 3 μm to the base by electroforming.

Since a sapphire substrate, silicon carbide substrate, lithium tantalite substrate and the like have a high Mohs hardness and hence, cutting with the above cutting blade is not always easy. Since the cutting blade has a thickness of about 20 μm, the streets for sectioning devices needs to have a width of about 50 μm. Therefore, in the case of a device measuring about 300 μm×300 μm, the area ratio of the streets to the wafer is large, thereby reducing productivity.

As means of dividing a plate-like workpiece such as a semiconductor wafer, a laser beam processing method for applying a laser beam capable of passing through the workpiece with its focusing point on the inside of the area to be divided has been attempted and disclosed by JP-A 2002-192367, for example. In the dividing method using this laser beam processing technique, a workpiece is divided by applying a laser beam having an infrared range capable of passing through the workpiece with its focusing point on the inside from one surface side thereof to continuously form deteriorated layers along the streets in the inside of the workpiece and then, exerting external force along the streets whose strength has been reduced by the formation of the deteriorated layers.

In the laser beam processing, the spot diameter of a laser beam is reduced as small as possible using a condenser having condenser lenses constituted by a set of condenser lenses to subject the workpiece to the micro-fabrication. When application of a laser beam is continued for a long time, however, the case housing the condenser becomes hot and the temperature of the case rises. As a result, a problem exists in that the case of the condenser thermally expands to dislocate the focusing point of the applied laser beam, thereby making it impossible to carry out the laser beam processing stably. FIG. 7 is a graph showing the dislocation of the focusing point caused by a rise in the temperature of the case of a condenser with the passage of laser beam processing time. In FIG. 7, the laser beam processing time is plotted on the horizontal axis, the position of the focusing point is plotted on the vertical axis, and the mark X denotes the position of the focusing point of a conventional laser beam machine. In FIG. 7, when the laser beam processing time was 0, the temperature of the case of the condenser was 23° C. As shown in FIG. 7, in the conventional laser beam machine, as the laser beam processing time becomes longer, the focusing point dislocates larger, and when laser beam processing is continued for 60 minutes, the focusing point dislocates by 12 μm.

### SUMMARY OF THE INVENTION

It is an object of the present invention to provide a laser beam machine which can keep the focusing point of a laser beam applied from a condenser at a predetermined position of a workpiece by correcting the dislocation of the focusing point of the laser beam, even when the temperature of the case of the condenser rises due to long-term continuous laser beam processing.

To attain the above object, according to the present invention, there is provided a laser beam machine comprising a workpiece holding means for holding a workpiece, a laser beam application-means comprising a condenser for applying a laser beam to the workpiece held on the workpiece holding means, and a focusing point position adjusting means for adjusting the position of the focusing point of the laser beam applied by the condenser, wherein
the machine further comprises a temperature detection means for detecting a temperature of the condenser and a control means for controlling the focusing point position adjusting means based on the temperature of the condenser detected by the temperature detection means.

The above control means comprises a storage means for storing a control map specifying the relationship between the temperature of the condenser and the dislocation of the focusing point and obtains the dislocation of the focusing point from the control map based on the temperature of the condenser detected by the temperature detection means, to control the focusing point position adjusting means based on the dislocation of the focusing point.

In the present invention, since the focusing position adjusting means is controlled based on the temperature of the condenser detected by the temperature detection means, the dislocation of the focusing point caused by a rise in the temperature of the condenser is corrected. Therefore, the focusing point of the laser beam applied to the workpiece can be maintained at a predetermined position and stable laser beam processing can be thereby carried out.

### BRIEF DESCRIPTION OF THE DRAWINGS

FIG. 1 is a perspective view of a laser beam machine constituted according to the present invention;

FIG. 2 is a block diagram schematically showing the constitution of laser beam application means provided in the laser beam machine shown in FIG. 1;

FIG. 3 is a perspective view of a semiconductor wafer as a workpiece;

FIGS. 4(a) and 4(b) are diagrams showing the position of the focusing point of a laser beam applied to the semiconductor wafer as the workpiece;

FIG. 5 is a flow chart showing the operation procedure of the control means provided in the laser beam machine shown in FIG. 1;

FIG. 6 is a control map stored in the read-only memory (ROM) 82 of a control means provided in the laser beam machine shown in FIG. 1; and

FIG. 7 is a graph showing the dislocation of the focusing point with the passage of the processing time of the laser beam machine.

### DETAILED DESCRIPTION OF THE PREFERRED EMBODIMENTS

A laser beam machine according to preferred embodiments of the present invention will be described in detail hereinunder with reference to the accompanying drawings.

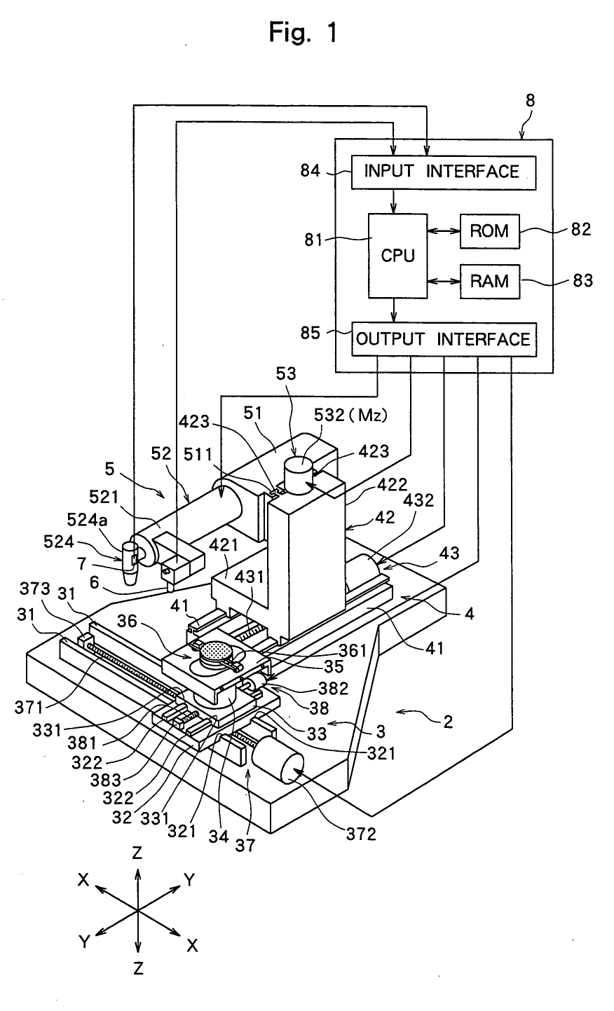

FIG. 1 is a perspective view of the laser beam machine constituted according to the present invention. The laser beam machine shown in FIG. 1 comprises a stationary base 2, a chuck table mechanism 3, which is mounted on the stationary base 2 in such a manner that it can move in a direction indicated by an arrow X and holds a workpiece, a laser beam application unit support mechanism 4 mounted on the stationary base 2 in such a manner that it can move in a direction indicated by an arrow Y perpendicular to the direction indicated by the arrow X, and a laser beam application unit 5, which is mounted on the laser beam application unit support mechanism 4 in such a manner that it can move in a direction indicated by an arrow Z.

The above chuck table mechanism 3 comprises a pair of guide rails 31 and 31, which are mounted on the stationary base 2 and arranged parallel to each other in the direction indicated by the arrow X, a first sliding block 32 mounted on the guide rails 31 and 31 in such a manner that it can move in the direction indicated by the arrow X, a second sliding block 33 mounted on the first sliding block 32 in such a manner that it can move in the direction indicated by the arrow Y, a support table 35 supported on the second sliding block 33 by a cylindrical member 34, and a chuck table 36 as a workpiece holding means. This chuck table 36 has an adsorption chuck 361 made of a porous material so that a disk-like semiconductor wafer as a workpiece is held on the adsorption chuck 361 by a suction means that is not shown. The chuck table 36 is rotated by a pulse motor (not shown) installed in the cylindrical member 34.

The above first sliding block 32 has, on its undersurface, a pair of to-be-guided guide grooves 321 and 321 to be fitted to the above pair of rails 31 and 31 and, on its top surface, a pair of guide rails 322 and 322 formed parallel to each other in the direction indicated by the arrow Y. The first sliding block 32 constituted as described above can move in the direction indicated by the arrow X along the pair of guide rails 31 and 31 by fitting the to-be-guided guide grooves 321 and 321 to the pair of guide rails 31 and 31, respectively. The chuck table mechanism 3 in the illustrated embodiment comprises a moving means 37 for moving the first sliding block 32 along the pair of guide rails 31 and 31 in the direction indicated by the arrow X. The moving means 37 includes a male screw rod 371 arranged between the above pair of guide rails 31 and 31 in parallel thereto, and a drive source such as a pulse motor 372 for driving the male screw rod 371. The male screw rod 371 is, at its one end, rotatably supported to a bearing block 373 fixed on the above stationary base 2 and is, at its other end, connected to the output shaft of the above pulse motor 372 via a speed reducer that is not known. The male screw rod 371 is screwed into a threaded through-hole formed in a female screw block (not shown) projecting from the undersurface of the center portion of the first sliding block 32. Therefore, by driving the male screw rod 371 in a normal direction or reverse direction with the pulse motor 372, the first sliding block 32 is moved along the guide rails 31 and 31 in the direction indicated by the arrow X.

The above second sliding block 33 has, on its undersurface, a pair of to-be-guided guide grooves 331 and 331 to be fitted to the pair of rails 322 and 322 provided on the top surface of the above first sliding block 32 and can move in the direction indicated by the arrow Y by fitting the to-be-guided guide grooves 331 and 331 to the pair of guide rails 322 and 322, respectively. The chuck table mechanism 3 in the illustrated embodiment has a moving means 38 for moving the second sliding block 33 in the direction indicated by the arrow Y along the pair of guide rails 322 and 322 provided on the first sliding block 32. The moving means 38 includes a male screw rod 381 that is arranged between the above pair of guide rails 322 and 322 in parallel thereto, and a drive source such as a pulse motor 382 for driving the male screw rod 381. The male screw rod 381 is, as its one end, rotatably supported to a bearing block 383 fixed on the top surface of the above first sliding block 32 and is, at its other end, connected to the output shaft of the above pulse motor 382 by a speed reducer that is not shown. The male screw rod 381 is screwed into a threaded through-hole formed in a female screw block (not shown) projecting from the undersurface of the center portion of the second sliding block 33. Therefore, by driving the male screw rod 381 in a normal direction or reverse direction with the pulse motor 382, the second sliding block 33 is moved along the guide rails 322 and 322 in the direction indicated by the arrow Y.

The above laser beam application unit support mechanism 4 comprises a pair of guide rails 41 and 41 mounted on the stationary base 2 and arranged parallel to each other in the indexing-feed direction indicated by the arrow Y and a movable support base 42 mounted on the guide rails 41 and 41 in such a manner that it can move in the direction indicated by the arrow Y. This movable support base 42 comprises a movable support portion 421 movably mounted on the guide rails 41 and 41 and a mounting portion 422 mounted on the movable support portion 421. The mounting portion 422 is, on one of its flanks, provided with a pair of guide rails 423 and 423 extending in parallel to each other in the direction indicated by the arrow Z. The laser beam application unit support mechanism 4 in the illustrated embodiment comprises moving means 43 for moving the movable support base 42 along the pair of guide rails 41 and 41 in the indexing direction indicated by the arrow Y. This moving means 43 includes a male screw rod 431 arranged between the above pair of guide rails 41 and 41 in parallel thereto, and a drive source such as a pulse motor 432 for driving the male screw rod 431. The male screw rod 431 is, at its one end, rotatably supported to a bearing block (not shown) fixed on the above stationary base 2 and is, at its other end, connected to the output shaft of the above pulse motor 432 by a speed reducer that is not shown. The male screw rod 431 is screwed into a threaded through-hole formed in a female screw block (not shown) projecting from the undersurface of the center portion of the movable support portion 421 constituting the movable support base 42. Therefore, by driving the male screw rod 431 in a normal direction or reverse direction with the pulse motor 432, the movable support base 42 is moved along the guide rails 41 and 41 in the indexing-feed direction indicated by the arrow Y.

The laser beam application unit 5 in the illustrated embodiment comprises a unit holder 51 and a laser beam application means 52 secured to the unit holder 51. The unit holder 51 has a pair of to-be-guided grooves 511 and 511 to be slidably fitted to the pair of guide rails 423 and 423 on the above mounting portion 422 and is supported in such a manner that it can move in the direction indicated by the arrow Z by fitting the to-be-guided guide grooves 511 and 511 to the above guide rails 423 and 423, respectively.

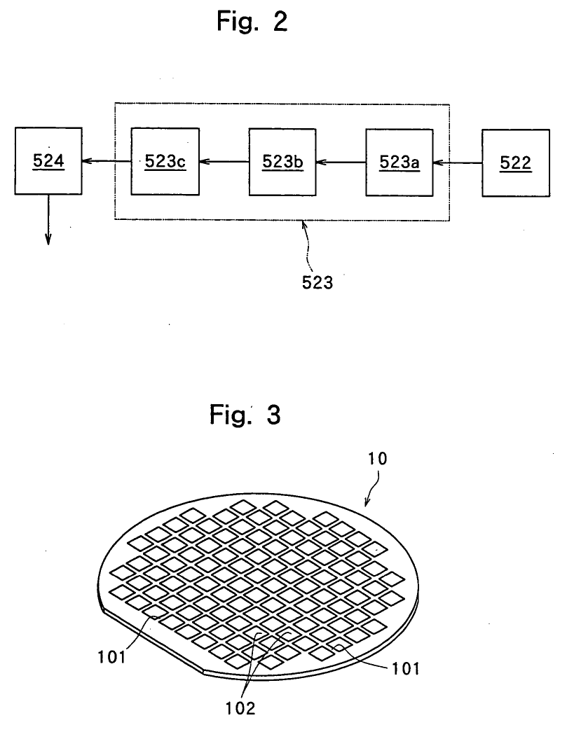

The illustrated laser beam application means 52 has a cylindrical casing 521 secured to the above unit holder 51 and extending substantially horizontally. In the casing 521, there are installed a laser beam oscillation means 522 and a laser beam modulation means 523 as shown in FIG. 2. A YAG laser oscillator or YVO4 laser oscillator may be used as the laser beam oscillation means 522. The laser beam modulation means 523 comprises a repetition frequency setting means 523a, a laser beam pulse width setting means 523b and a laser beam output setting means 523c. The repetition frequency setting means 523a, laser beam pulse width setting means 523b and laser beam output setting means 523c constituting the laser beam modulation means 523 may be known devices to people of ordinary skill in the art and therefore, detailed descriptions of their structures are omitted in this text. A condenser 524 housing condenser lenses (not shown) that are constituted by a set of condenser lenses and may be a known formation is attached to the end of the above casing 521.

A laser beam oscillated from the above laser beam oscillation means 522 reaches the condenser 524 through the laser beam modulation means 523. The repetition frequency setting means 523a of the laser beam modulation means 523 changes the laser beam into a pulse laser beam having a predetermined repetition frequency, the laser beam pulse width setting means 523b changes the pulse width of the pulse laser beam to a predetermined width, and the laser beam output setting means 523c sets the output of the pulse laser beam to a predetermined value.

Returning to FIG. 1, an image pick-up means 6 is situated at the front end of the casing 521 constituting the above laser beam application means 52. This image pick-up means 6 in the illustrated embodiment comprises an infrared illuminating means for applying infrared radiation to the workpiece, an optical system for capturing infrared radiation applied by the infrared illuminating means, and an image pick-up device (infrared CCD) for outputting an electric signal corresponding to infrared radiation captured by the optical system in addition to an ordinary image pick-up device (CCD) for taking an image with visible radiation. An image signal is transmitted to a control means later described.

The laser beam application unit 5 in the illustrated embodiment comprises a focusing point position adjusting means 53 for moving the unit holder 51 along the pair of guide rails 423 and 423 in the direction shown by the arrow Z. The focusing point position adjusting means 53 comprises a male screw rod (not shown) arranged between the pair of guide rails 423 and 423 and a drive source such as a pulse motor 532 (Mz) for driving the male screw rod, like the above moving means. By driving the male screw rod (not shown) in a normal direction or reverse direction with the pulse motor 532 (Mz), the unit holder 51 and the laser beam application means 52 are moved along the guide rails 423 and 423 in the direction shown by the arrow Z. In the illustrated embodiment, the laser beam application means 52 is so constituted as to move up by driving the pulse motor 532 (Mz) in the normal direction and to move down by driving the pulse motor 532 (Mz) in the reverse direction. Therefore, the focusing point position adjusting means 53 can adjust the position of the focusing point of the laser beam applied by the condenser 524 attached to the end of the casing 521.

The laser beam machine in the illustrated embodiment has a temperature detection means 7 for detecting the temperature of the above condenser 524 and a control means 8 for controlling the focusing point position adjusting means 53 based on the temperature of the condenser 524 detected by the temperature detection means 7. The temperature detection means 7 is mounted on the case 524a of the condenser 524 and supplies a detection signal to the control means 8. The control means 8 is composed of a computer which comprises a central processing unit (CPU) 81 for carrying out arithmetic processing based on a control program, a read-only memory (ROM) 82 for storing the control program, etc., a read/write random access memory (RAM) 83 for storing the results of operations, an input interface 84 and an output interface 85. Detection signals from the temperature detection means 7, the image pick-up means 6, etc. are input to the input interface 84 of the control means 8 thus constituted. Control signals are output to the above pulse motor 532 (Mz), the above pulse motor 372, pulse motor 382, pulse motor 432 and laser beam application means 52 from the output interface 85.

The laser beam machine in the illustrated embodiment is constituted as described above, and its operation of processing the semiconductor wafer 10 shown in FIG. 3 will be described hereinbelow.

In the semiconductor wafer 10 shown in FIG. 3, a plurality of areas are sectioned by a plurality of streets 101 formed in a lattice pattern on the front surface, and a circuit 102 such as IC, LSI or the like is formed in each of the sectioned areas. The semiconductor wafer 10 constituted as described above is suction-held on the chuck table 36 in such a manner that the back surface faces up. The chuck table 36 suction-holding the semiconductor wafer 10 is moved along the guide rails 31 and 31 by the operation of the moving means 37 and positioned right below the image pick-up means 6 mounted on the laser beam application unit 5.

After the chuck table 36 is positioned right below the image pick-up means 6, image processing such as pattern matching is carried out to align a street 101 that is formed on the semiconductor wafer 10 held on the chuck table 36 with the condenser 524 of the laser beam application means 52 for applying a laser beam along the street 101 by the image pick-up means 6 and a control means that is not shown, thereby performing the alignment of a laser beam application position. Although the surface, on which the street 101 is formed, of the semiconductor wafer 10 faces down at this point, an image of the street 101 can be taken from the back surface as the image pick-up means 6 comprises infrared illuminating means, an optical system for capturing infrared radiation and an image pick-up device (infrared CCD) for outputting an electric signal corresponding to the infrared radiation as described above.

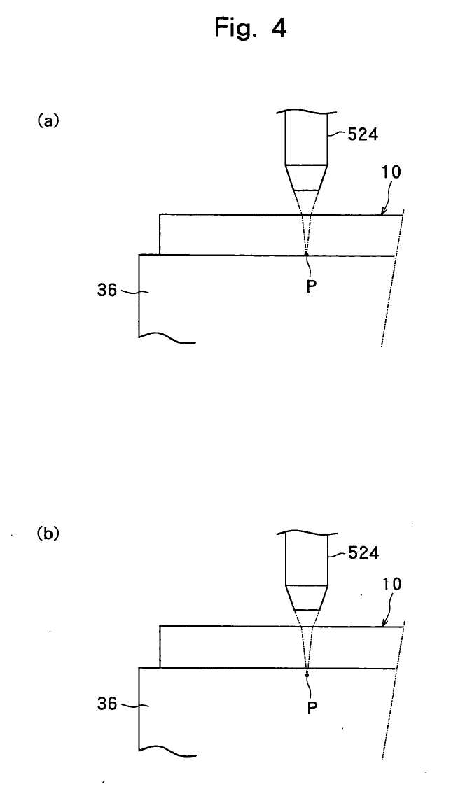

After the street 101 formed on the semiconductor wafer 10 held on the chuck table 36 is detected and the alignment of the laser beam application position is carried out, the chuck table 36 is moved to a laser beam application range where the condenser 524 of the laser beam application unit 5 for applying a laser beam is located, and a laser beam is applied along the street 101 of the semiconductor wafer 10 from the condenser 524 of the laser beam application means 52. At this point, the laser beam is applied with its focusing point on the inside, that is, near the front surface (surface on the underside), through the back surface (surface on the topside) of the semiconductor wafer 10, as shown in FIG. 4(a), thereby forming a deteriorated layer along the street 101 in the inside of the semiconductor wafer 10.

The above laser beam processing conditions will be described hereinbelow.

The chuck table 36 is moved in the direction indicated by the arrow X (see FIG. 1) at a predetermined feed rate (for example, 100 mm/sec) while a pulse laser beam is applied to a predetermined street 101 from the condenser 524 of the laser beam application means 52, from the back surface of the semiconductor wafer 10. The following infrared laser beam is used as the laser beam.
Light source: Nd:YVO4 pulse laser
Wavelength: 1,064 nm
Pulse energy: 10 μJ
Repetition frequency: 100 kHz
Pulse width: 40 ns
Focusing spot diameter: 1 μm
Energy density of focusing point: 3.2×10E10W/cm²

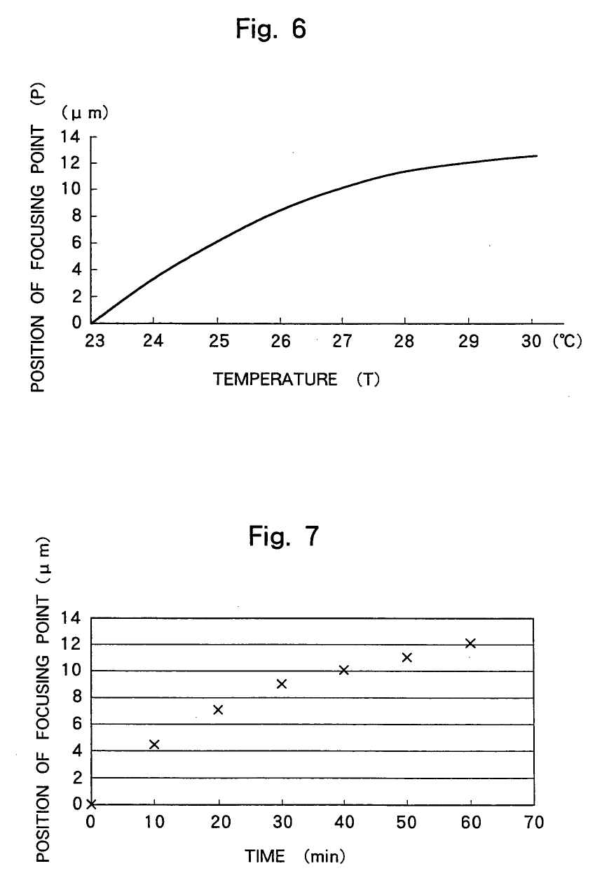

In the above laser beam processing, the condenser 524 housing condenser lenses that are constituted by a set of condenser lenses for applying a laser beam becomes hot and the temperature of the case 524a rises. When the temperature of the case 524a rises, the position of the focusing point (P) of the laser beam applied from the condenser 524 dislocates downward from the vicinity of the front surface (surface on the underside) of the semiconductor wafer 10 as shown in FIG. 4(b). Therefore, in the illustrated embodiment, the temperature of the condenser 524 is detected by the temperature detection means 7, and the control means 8 controls the pulse motor 532 (Mz) of the focusing point position adjusting means 53 based on a detection signal from this temperature detection means 7 to correct the dislocation of the focusing point of the laser beam applied from the condenser 524. To carry out this correction control, the control map shown in FIG. 6 is stored in the read-only memory (ROM) 82 of the control means 8. This control map specifies the relationship between the temperature (T) of the case 524a of the condenser 524 and the dislocation of the focusing point (P). The relationship between the temperature (T) of the case 524a of the condenser 524 and the position of the focusing point (P) in the control map shown in FIG. 6 is obtained by experimentation of the condenser 524 to be mounted.

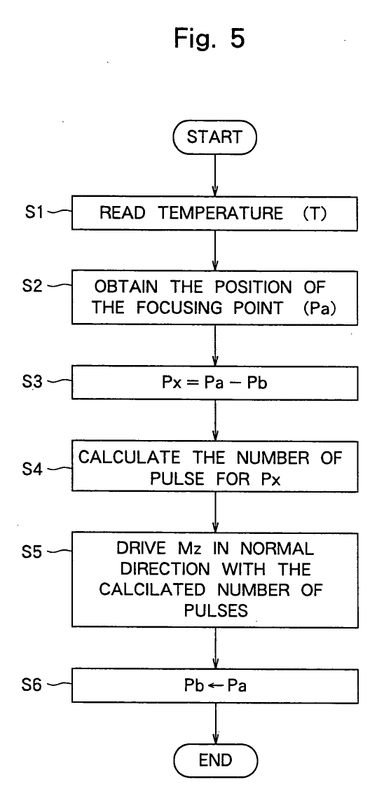

A description is subsequently given of the correction control of the dislocation of the focusing point by the control means 8 with reference to the flow chart shown in FIG. 5. The routine shown in FIG. 5 is repeated at every predetermined period.

The control means 8 reads the temperature (T) of the condenser 524 detected by the temperature detection means 7 in step S1. Then, the control means 8 proceeds to step S2 to obtain the position of the focusing point (Pa) for the temperature (T) detected by the temperature detection means 7 from the control map shown in FIG. 6 stored in the read-only memory (ROM) 82, and stores this value (Pa) in the first domain of the random access memory (RAM) 82 temporarily. Thereafter, the control means 8 proceeds to step S3 to obtain a difference (Px=Pa−Pb) between the obtained position of the focusing point (Pa) this time obtained and temporarily stored in the first domain and the position of the focusing point (Pb) for the temperature (T) previously detected by the temperature detection means 7. The position of the focusing point (Pb) for the temperature previously detected by the temperature detection means 7 is temporarily stored in the second domain of the random access memory (RAM) 83 and “0” (P0) is initially stored in the second domain as the position of the focusing point.

After the difference (Px) between the position of the focusing point (Pa) obtained this time in the above step S3 and the position of the focusing point (Pb) for the temperature (T) previously detected by the temperature detection means 7 is obtained in the above step S3, the control means 8 proceeds to step S4 to calculate how many pulses the pulse motor 532 (Mz) of the focusing point position adjusting means 53 must be driven to correct the dislocation (Px) of the focusing point. Then, the control means 8 proceeds to step S5 to apply the obtained number of pulses to the pulse motor 532 (Mz) to drive it in the normal direction. Thereafter, the control means 8 proceeds to step S6 to transfer the obtained position of the focusing point (Pa) temporarily stored in the first domain of the random access memory (RAM) 83 to the second domain as the previously obtained position of the focusing point (Pb), and clear up the obtained position of the focusing point (Pa) temporarily stored in the first domain.

As described above, in the illustrated embodiment, the temperature of the condenser 524 is detected by the temperature detection means 7, and the pulse motor 532 (Mz) of the focusing point position adjusting means 53 is controlled by the control means 8 based on a detection signal from the temperature detection means 7 to correct the dislocation of the focusing point of the laser beam applied from the condenser 524. Therefore, even when the condenser 524 becomes hot due to long-term continuous laser beam processing and the temperature of the case 524a rises, the focusing point is kept at a predetermined position of the workpiece, whereby stable high-precision laser beam processing can be ensured.

1. A laser beam machine comprising a workpiece holding means for holding a workpiece, a laser beam application means comprising a condenser for applying a laser beam to the workpiece held on the workpiece holding means, and a focusing point position adjusting means for adjusting the position of the focusing point of the laser beam applied by the condenser, wherein
the machine further comprises a temperature detection means for detecting a temperature of the condenser and a control means for controlling the focusing point position adjusting means based on the temperature of the condenser detected by the temperature detection means.

2. The laser beam machine according to claim 1, wherein the control means comprises storage means for storing a control map specifying the relationship between the temperature of the condenser and the dislocation of the focusing point and obtains the dislocation of the focusing point from the control map based on the temperature of the condenser detected by the temperature detection means, to control the focusing point position adjusting means based on the dislocation of the focusing point.
